(19) United States
(12) Patent Application Publication
(10) Pub. No.: US 2023/0300568 A1
(43) Pub. Date: Sep. 21, 2023

(54) USER EQUIPMENT COORDINATED POSITIONING

(71) Applicant: QUALCOMM Incorporated, San Diego, CA (US)

(72) Inventors: Liang ZHAO, Saratoga, CA (US); Le Nguyen LUONG, San Diego, CA (US); Rayman Wai PON, Cupertino, CA (US); Cheng-Han WANG, San Jose, CA (US); Bala RAMASAMY, San Marcos, CA (US); Santosh Kumar GUPTA, San Jose, CA (US); Michael KOHLMANN, San Francisco, CA (US)

(21) Appl. No.: 17/698,754

(22) Filed: Mar. 18, 2022

(51) Int. Cl. H04W 4/029; G08G 1/005

(52) U.S. Cl. CPC H04W 4/029; G08G 1/005

(57) ABSTRACT

Disclosed are systems and techniques for wireless communications. For example, a first user equipment (UE) can receive positioning data corresponding to a second UE. In some cases, the first UE can determine a relative position between the first UE and the second UE. In some aspects, the first UE can determine a first location estimate of the first UE based on the positioning data corresponding to the second UE and the relative position between the first UE and the second UE.

### FIELD OF THE DISCLOSURE

Aspects of the present disclosure generally relate to wireless communication. In some implementations, examples are described for performing coordinated positioning among user equipment (UE) devices.

### BACKGROUND OF THE DISCLOSURE

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, and a fourth-generation (4G) service (e.g., Long-Term Evolution (LTE), WiMax). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G/LTE standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one example, a method is provided for wireless communication. The method includes: receiving, by a first user equipment (UE), positioning data corresponding to a second UE; determining a relative position between the first UE and the second UE; and determining a first location estimate of the first UE based on the positioning data corresponding to the second UE and the relative position between the first UE and the second UE.

In another example, an apparatus for wireless communication is provided that includes at least one memory and at least one processor (e.g., implemented in circuitry) coupled to the at least one memory and configured to: receive positioning data corresponding to a user equipment (UE); determine a relative position between the apparatus and the UE; and determine a first location estimate of the apparatus based on the positioning data corresponding to the UE and the relative position between the apparatus and the UE.

In another example, a non-transitory computer-readable medium is provided for performing wireless communications, which has stored thereon instructions that, when executed by one or more processors, cause the one or more processors to: receive, by a first user equipment (UE), positioning data corresponding to a second UE; determine a relative position between the first UE and the second UE; and determine a first location estimate of the first UE based on the positioning data corresponding to the second UE and the relative position between the first UE and the second UE.

In another example, an apparatus for wireless communications is provided. The apparatus includes: means for receiving, by a first user equipment (UE), positioning data corresponding to a second UE; means for determining a relative position between the first UE and the second UE; and means for determining a first location estimate of the first UE based on the positioning data corresponding to the second UE and the relative position between the first UE and the second UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an exemplary wireless communications system, according to aspects of the disclosure.

FIG. 2A and FIG. 2B illustrate examples of wireless network structures, according to aspects of the disclosure.

FIG. 3 is a diagram illustrating an example of various user equipment (UEs) communicating over direct communication interfaces (referred to as a PC5 interface or a sidelink interface) and wide area network (Uu) interfaces, according to aspects of the disclosure.

FIG. 4 is a block diagram illustrating an example of a computing system of a vehicle, according to aspects of the disclosure.

FIG. 5 is a block diagram illustrating an example of a computing system of a user device, according to aspects of the disclosure.

FIG. 6 is a diagram illustrating an example wireless communications system for implementing user equipment coordinated positioning, according to aspects of the disclosure.

FIG. 7 is a diagram illustrating another example wireless communications system for implementing user equipment coordinated positioning, according to aspects of the disclosure.

FIG. 8 is a sequence diagram illustrating an example of a sequence for performing user equipment coordinated positioning, according to aspects of the disclosure.

FIG. 9 is a flow diagram illustrating an example of a process for performing user equipment coordinated positioning, according to aspects of the disclosure.

FIG. 10 is a block diagram illustrating an example of a computing system, according to aspects of the disclosure.

### DETAILED DESCRIPTION

Certain aspects and embodiments of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects and embodiments described herein may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

Wireless communication networks are deployed to provide various communication services such as voice, video, packet data, messaging, broadcast, and the like. A wireless communication network may support both access links and sidelinks for communication between wireless devices. An access link may refer to any communication link between a client device (e.g., a user equipment (UE), a station (STA), or other client device) and a base station (e.g., a 3GPP gNB, a 3GPP eNB, a Wi-Fi access point (AP), or other base station). For example, an access link may support uplink signaling, downlink signaling, connection procedures, etc.

A sidelink may refer to any communication link between client devices (e.g., UEs, STAB, etc.). For example, a sidelink may support device-to-device (D2D) communications, vehicle-to-everything (V2X) and/or vehicle-to-vehicle (V2V) communications, message relaying, discovery signaling, beacon signaling, or any combination of these or other signals transmitted over-the-air from one UE to one or more other UEs. In some examples, sidelink communications may be transmitted using a licensed frequency spectrum or an unlicensed frequency spectrum (e.g., 5 GHz or 6 GHz). As used herein, the term sidelink may refer to 3GPP sidelink (e.g., using a PC5 sidelink interface), Wi-Fi direct communications (e.g., according to a Dedicated Short Range Communication (DSRC) protocol), or using any other direct device-to-device communication protocol.

In some cases, a UE may support both absolute and relative positioning. For example, absolute positioning can include determining a global location (e.g., geographic coordinates) of a UE. In some aspects, a UE (e.g., pedestrian UE, vehicle UE, or any other UE) may use the Global Navigation Satellite System (GNSS), such as the Global Positioning System (GPS), to determine the absolute position of the UE. In some cases, the accuracy of the absolute position determined by the UE can depend on the hardware and/or software capabilities of the UE, the operating mode, and/or environmental conditions (e.g., line-of-sight to satellites, weather, interference, antenna location, etc.).

In some examples, relative positioning can include determining a distance and direction between two UEs (e.g., between a pedestrian UE and a vehicle UE). In some cases, relative positioning can be implemented using radio frequency (RF) ranging techniques that can include ultra-wideband (UWB), sidelink, WiFi, Bluetooth™, and/or other wireless protocols. In one example, UWB can be used to determine relative positioning having a level of accuracy within +/−10 cm.

Systems, apparatuses, processes (also referred to as methods), and computer-readable media (collectively referred to as “systems and techniques”) are described herein for performing user equipment (UE) coordinated positioning. The systems and techniques provide the ability for a first UE to calculate an absolute position based on position data obtained from a second UE. In some aspects, the position data from the second UE can be adjusted based on the relative position between the first UE and the second UE. In some cases, the relative position between the first UE and the second UE can be based on ultra-wideband (UWB) ranging techniques. In some examples, the position data received by the first UE from the second UE can include an absolute position (e.g., position level coupling) of the second UE. In some cases, the position data received by the first UE from the second UE can include measurements or data (e.g., measurement level coupling) obtained by the second UE from one or more GNSS satellites.

In some cases, the first UE and the second UE can have different hardware and/or software configurations that can provide different positioning capabilities. For example, a vehicle may be equipped with high precision positioning components (e.g., automotive GNSS antenna) that may outperform the components of a pedestrian UE. In some cases, UE coordinated positioning can be used to leverage hardware/software components from a vehicle to improve the positioning accuracy of a pedestrian UE. In some examples, a pedestrian UE may save power by leveraging position data from a vehicle (e.g., pedestrian UE can leverage position data from vehicle and minimize usage of GNSS receivers).

In some examples, a pedestrian UE (e.g., mobile phone) may have higher positioning accuracy than a vehicle. For instance, the pedestrian UE may have newer hardware/software that may outperform a vehicle that is not equipped with high precision GNSS. In some examples, the vehicle may leverage position data from the pedestrian UE to improve the accuracy of its position calculation. In another example, a UE may correspond to a drone (e.g., delivery drone) that may improve positioning accuracy by using coordinated positioning that may be derived from one or more other UEs (e.g., pedestrian UE, vehicle, etc.). For example, a delivery drone may improve positioning accuracy by implementing coordinated positioning with a vehicle that may be equipped with high precision GNSS.

In some cases, a vehicle, a pedestrian UE, and/or any other type of UE may transmit and/or receive data (e.g., position data including position level coupling and/or measurement level coupling) using any suitable wireless and/or wired communications protocol. For example, a vehicle and a pedestrian UE may communicate position data using sidelink, WiFi, Bluetooth™, Universal Serial Bus (USB), Near Field Communications (NFC), UWB, and/or any other suitable communications protocol. In some cases, position data can also include an accuracy metric. For instance, a vehicle may send an absolute location that is estimated to be within +/−5 meters of accuracy.

In some examples, a UE may compare a calculated position (e.g., based on position data from another UE) with a locally derived position (e.g., based on local GNSS data). In some cases, a UE may determine that a delta between the calculated position and the locally derived position exceeds a threshold value. In some aspects, a UE may select the position estimate (e.g., calculated vs. local) that has a higher level of accuracy. In some cases, the UE may combine the two position estimates using a weighted combination that can be based on a corresponding accuracy metric. In some aspects, the UE may process the position estimates and/or the accuracy estimates using a position multi-sensor fusion engine (e.g., Kalman filter, machine learning algorithm, etc.).

In some aspects, a pedestrian UE and a vehicle may perform UE coordinated positioning with data exchange. In some cases, the data can include real-time kinematic (RTK) positioning data that can be used to correct errors associated with GNSS measurements. For instance, a pedestrian UE and a vehicle may be associated with different networks having different coverage areas. In some cases, a vehicle may not have access to a data network and may rely on RTK data from a pedestrian UE. In some cases, a pedestrian UE may not have access to a data network and may rely on RTK data from a vehicle. In some aspects, the RTK data can be generated or customized based on position data. For example, a pedestrian UE may remove satellite information that is associated with a satellite that is outside the line-of-sight of the vehicle (e.g., based on position data).

In some examples, UE coordinated positioning can be used in connection with public transportation. For example, a pedestrian UE travelling within a public transportation vehicle may not be able to obtain a geolocation because a GNSS signal may not be available (e.g., subway underground, bus travelling through urban canyon, etc.). In some aspects, the pedestrian UE may use UE coordinated positioning to communicate with the public transportation vehicle and calculate its geolocation.

As used herein, the term “communication unit” is a system, device, or component of a UE (e.g., a vehicle, a user device, etc.) and/or other device (e.g., a road side unit (RSU) or other device) that may include a telematics control unit (TCU), a network access device (NAD), a modem, a subscriber identity module (SIM), a transceiver (or individual receiver and/or transmitter), any combination thereof, and/or other system, device, or component configured to perform wireless communication operations.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, tracking device, wearable device (e.g., smart watch, glasses, an extended reality (XR) device such as a virtual reality (VR) headset, an augmented reality (AR) headset or glasses, or a mixed reality (MR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “user device,” a “user terminal” or UT, a “client device,” a “wireless device,” a “wireless communication device,” a “subscriber device,” a “subscriber terminal,” a “subscriber station,” a “mobile device,” a “mobile terminal,” a “mobile station,” or variations thereof. Generally, UEs may communicate with a core network via a RAN, and through the core network the UEs may be connected with external networks such as the Internet and with other UEs. UEs may also communicate with other UEs and/or other devices as described herein. In some cases, other mechanisms of connecting to the core network, the Internet, and other UEs are also possible for the UEs, such as over wired access networks, wireless local area network (WLAN) networks (e.g., based on IEEE 802.11, based on ultra-wideband (UWB), etc.), and so on.

A base station may operate according to one of several RATs in communication with UEs, RSUs, and/or other devices, depending on the network in which it is deployed. In some cases, a base station may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, a forward traffic channel, etc.). As used herein the term traffic channel (TCH) may refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference RF signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

A road side unit (RSU) is a device that may transmit and receive messages over a communications link or interface (e.g., a cellular-based sidelink or PC5 interface, an 802.11 or WiFi™ based Dedicated Short Range Communication (DSRC) interface, and/or other interface) to and from one or more UEs, other RSUs, and/or base stations. An example of messages that may be transmitted and received by an RSU includes vehicle-to-everything (V2X) messages, which are described in more detail below. RSUs may be located on various transportation infrastructure systems, including roads, bridges, parking lots, toll booths, and/or other infrastructure systems. In some examples, an RSU may facilitate communication between UEs (e.g., vehicles, pedestrian user devices, and/or other UEs) and the transportation infrastructure systems. In some implementations, a RSU may be in communication with a server, base station, and/or other system that may perform centralized management functions.

An RSU may communicate with a communications system of a UE. For example, an intelligent transport system (ITS) of a UE (e.g., a vehicle and/or other UE) may be used to generate and sign messages for transmission to an RSU and to validate messages received from an RSU. An RSU may communicate (e.g., over a PC5 interface, DSRC interface, etc.) with vehicles traveling along a road, bridge, or other infrastructure system in order to obtain traffic-related data (e.g., time, speed, location, etc. of the vehicle). In some cases, in response to obtaining the traffic-related data, the RSU may determine or estimate traffic congestion information (e.g., a start of traffic congestion, an end of traffic congestion, etc.), a travel time, and/or other information for a particular location. In some examples, the RSU may communicate with other RSUs (e.g., over a PC5 interface, DSRC interface, etc.) in order to determine the traffic-related data. The RSU may transmit the information (e.g., traffic congestion information, travel time information, and/or other information) to other vehicles, pedestrian UEs, and/or other UEs. For example, the RSU may broadcast or otherwise transmit the information to any UE (e.g., vehicle, pedestrian UE, etc.) that is in a coverage range of the RSU.

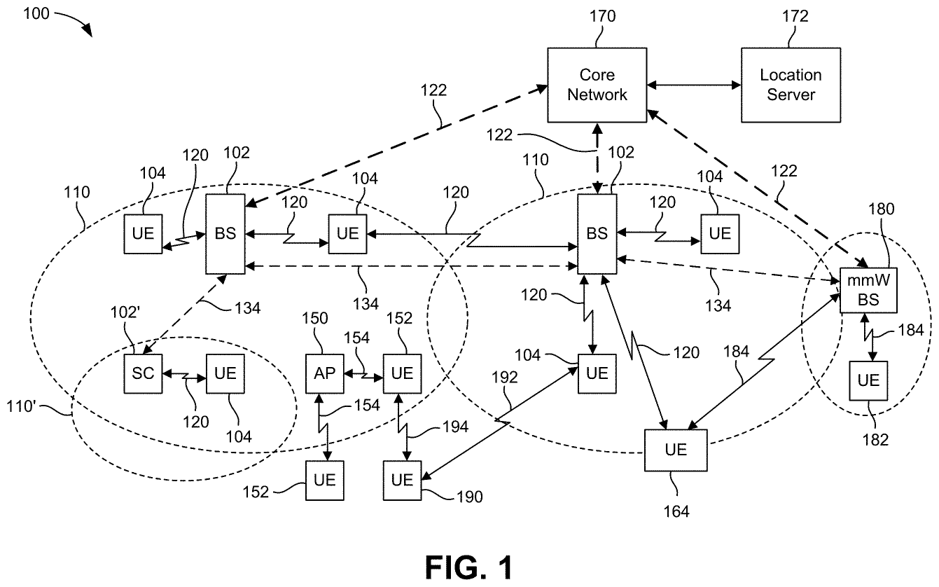

According to various aspects, FIG. 1 illustrates an example of a wireless communications system 100. The wireless communications system 100 (which may also be referred to as a wireless wide area network (WWAN)) may include various base stations 102 and various UEs 104. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a 4G/LTE network, or gNBs where the wireless communications system 100 corresponds to a 5G/NR network, or a combination of both, and the small cell base stations may include femtocells, picocells, microcells, etc.

The base stations 102 may collectively form a radio access network (RAN) and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum (e.g., utilizing LTE or NR technology and use the same 5 GHz unlicensed frequency spectrum as used by the WLAN AP 150). The wireless communications system 100 may further include a millimeter wave (mmW) base station 180 that may operate in mmW frequencies and/or near mmW frequencies in communication with a UE 182. In some cases, mmW frequencies may be referred to as the FR2 band (e.g., including a frequency range of 24250 MHz to 52600 MHz). In some examples, the wireless communications system 100 may include one or more base stations (referred to herein as “hybrid base stations”) that operate in both the mmW frequencies (and/or near mmW frequencies) and in sub-6 GHz frequencies (referred to as the FR1 band, e.g., including a frequency range of 450 to 6000 MHz). In some examples, the mmW base station 180, one or more hybrid base stations (not shown), and the UE 182 may utilize beamforming (transmit and/or receive) over a mmW communication link 184 to compensate for the extremely high path loss and short range. The wireless communications system 100 may further include a UE 164 that may communicate with a macro cell base station 102 over a communication link 120 and/or the mmW base station 180 over a mmW communication link 184.

In some examples, in order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, UWB, and so on.

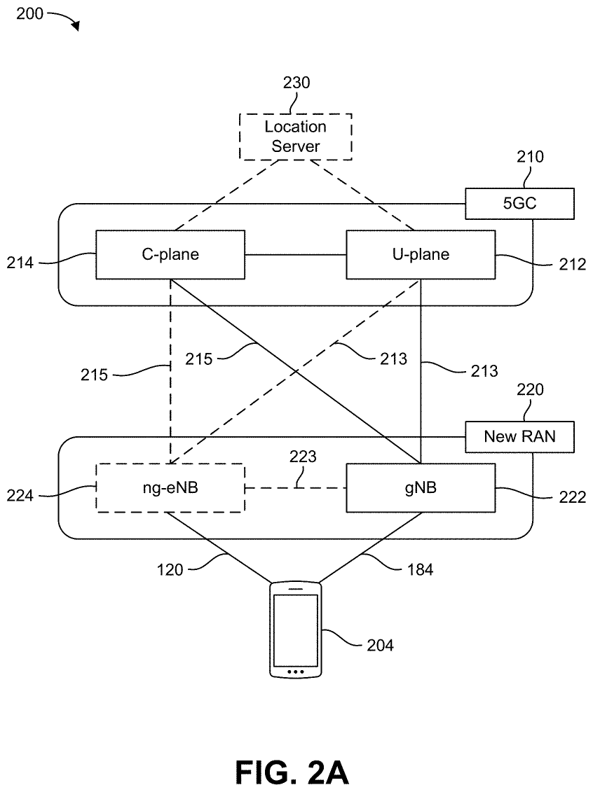

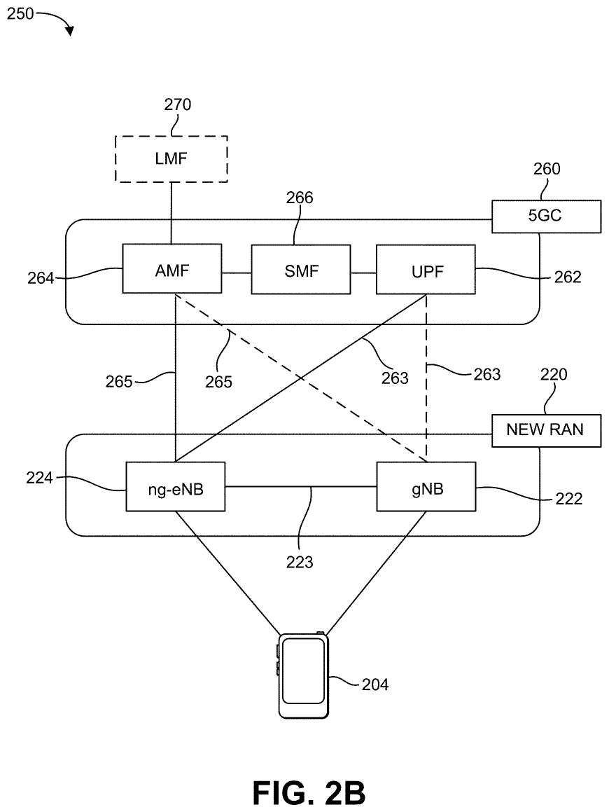

According to various aspects, FIG. 2A illustrates an example wireless network structure 200. For example, a 5GC 210 (also referred to as a Next Generation Core (NGC)) may be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the control plane functions 214 and user plane functions 212. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1).

In some aspects, wireless network structure 200 may include location server 230, which may be in communication with the 5GC 210 to provide location assistance for UEs 204. The location server 230 may be implemented as a plurality of separate servers (e.g., physically separate servers, different software modules on a single server, different software modules spread across multiple physical servers, etc.), or alternately may each correspond to a single server. The location server 230 may be configured to support one or more location services for UEs 204 that may connect to the location server 230 via the core network, 5GC 210, and/or via the Internet (not illustrated). Further, the location server 230 may be integrated into a component of the core network, or alternatively may be external to the core network. In some examples, the location server 230 may be operated by a carrier or provider of the 5GC 210, a third party, an original equipment manufacturer (OEM), or other party. In some cases, multiple location servers may be provided, such as a location server for the carrier, a location server for an OEM of a particular device, and/or other location servers. In such cases, location assistance data may be received from the location server of the carrier and other assistance data may be received from the location server of the OEM.

According to various aspects, FIG. 2B illustrates another example wireless network structure 250. In some examples, 5GC 260 may be viewed functionally as control plane functions, provided by an access and mobility management function (AMF) 264, and user plane functions, provided by a user plane function (UPF) 262, which operate cooperatively to form the core network (i.e., 5GC 260). User plane interface 263 and control plane interface 265 connect the ng-eNB 224 to the 5GC 260 and specifically to UPF 262 and AMF 264, respectively. In some examples, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). The base stations of the New RAN 220 communicate with the AMF 264 over the N2 interface and with the UPF 262 over the N3 interface.

The functions of the AMF 264 may include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 may also interact with an authentication server function (AUSF) (not shown) and the UE 204, and may receive an intermediate key established as a result of the UE 204 authentication process.

In the case of authentication based on a UMTS (universal mobile telecommunications system) subscriber identity module (USIM), the AMF 264 may retrieve the security material from the AUSF. The functions of the AMF 264 may also include security context management (SCM). The SCM may receive a key from the SEAF that it may use to derive access-network specific keys. The functionality of the AMF 264 may also include location services management for regulatory services, transport for location services messages between the UE 204 and a location management function (LMF) 270 (which acts as a location server 230), transport for location services messages between the New RAN 220 and the LMF 270, evolved packet system (EPS) bearer identifier allocation for interworking with the EPS, and UE 204 mobility event notification. In addition, the AMF 264 may also support functionalities for non-3GPP access networks.

In some cases, UPF 262 may perform functions that include serving as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink and/or downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. In some aspects, UPF 262 may also support transfer of location services messages over a user plane between the UE 204 and a location server, such as a secure user plane location (SUPL) location platform (SLP), not shown in FIG. 2B.

In some examples, the functions of SMF 266 may include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 may be referred to as the N11 interface.

In some aspects, wireless network structure 250 may include an LMF 270, which may be in communication with the 5GC 260 to provide location assistance for UEs 204. The LMF 270 may be implemented as a plurality of separate servers (e.g., physically separate servers, different software modules on a single server, different software modules spread across multiple physical servers, etc.), or alternately may each correspond to a single server. The LMF 270 may be configured to support one or more location services for UEs 204 that may connect to the LMF 270 via the core network, 5GC 260, and/or via the Internet (not illustrated). The SLP may support similar functions to the LMF 270, but whereas the LMF 270 may communicate with the AMF 264, New RAN 220, and UEs 204 over a control plane (e.g., using interfaces and protocols intended to convey signaling messages and not voice or data), the SLP may communicate with UEs 204 and external clients (not shown in FIG. 2B) over a user plane (e.g., using protocols intended to carry voice and/or data like the transmission control protocol (TCP) and/or IP).

In some cases, LMF 270 and/or the SLP may be integrated with a base station, such as the gNB 222 and/or the ng-eNB 224. When integrated with the gNB 222 and/or the ng-eNB 224, the LMF 270 and/or the SLP may be referred to as a “location management component,” or “LMC.” As used herein, references to LMF 270 and SLP include both the case in which the LMF 270 and the SLP are components of the core network (e.g., 5GC 260) and the case in which the LMF 270 and the SLP are components of a base station.

As described above, wireless communications systems support communication among multiple UEs. In various examples, wireless communications systems may be configured to support device-to-device (D2D) communication and/or vehicle-to-everything (V2X) communication. V2X may also be referred to as Cellular V2X (C-V2X). V2X communications may be performed using any radio access technology, such as LTE, 5G, WLAN, or other communication protocol. In some examples, UEs may transmit and receive V2X messages to and from other UEs, road side units (RSUs), and/or other devices over a direct communications link or interface (e.g., a PC5 or sidelink interface, an 802.11p DSRC interface, and/or other communications interface) and/or via the network (e.g., an eNB, a WiFi AP, and/or other network entity). The communications may be performed using resources assigned by the network (e.g., an eNB or other network device), resources pre-configured for V2X use, and/or using resources determined by the UEs (e.g., using clear channel assessment (CCA) with respect to resources of an 802.11 network).

V2X communications may include communications between vehicles (e.g., vehicle-to-vehicle (V2V)), communications between vehicles and infrastructure (e.g., vehicle-to-infrastructure (V2I)), communications between vehicles and pedestrians (e.g., vehicle-to-pedestrian (V2P)), and/or communications between vehicles and network severs (vehicle-to-network (V2N)). For V2V, V2P, and V2I communications, data packets may be sent directly (e.g., using a PC5 interface, using an 802.11 DSRC interface, etc.) between vehicles without going through the network, eNB, or gNB. V2X-enabled vehicles, for instance, may use a short-range direct-communication mode that provides 360° non line-of-sight (NLOS) awareness, complementing onboard line-of-sight (LOS) sensors, such as cameras, radio detection and ranging (RADAR), Light Detection and Ranging (LIDAR), among other sensors. The combination of wireless technology and onboard sensors enables V2X vehicles to visually observe, hear, and/or anticipate potential driving hazards (e.g., at blind intersections, in poor weather conditions, and/or in other scenarios). V2X vehicles may also understand alerts or notifications from other V2X-enabled vehicles (based on V2V communications), from infrastructure systems (based on V2I communications), and from user devices (based on V2P communications). Infrastructure systems may include roads, stop lights, road signs, bridges, toll booths, and/or other infrastructure systems that may communicate with vehicles using V2I messaging.

Depending on the desired implementation, sidelink communications may be performed according to 3GPP communication protocols sidelink (e.g., using a PC5 sidelink interface according to LTE, 5G, etc.), Wi-Fi direct communication protocols (e.g., DSRC protocol), or using any other device-to-device communication protocol. In some examples, sidelink communication may be performed using one or more Unlicensed National Information Infrastructure (U-NII) bands. For instance, sidelink communications may be performed in bands corresponding to the U-NII-4 band (5.850-5.925 GHz), the U-NII-5 band (5.925-6.425 GHz), the U-NII-6 band (6.425-6.525 GHz), the U-NII-7 band (6.525-6.875 GHz), the U-NII-8 band (6.875-7.125 GHz), or any other frequency band that may be suitable for performing sidelink communications.

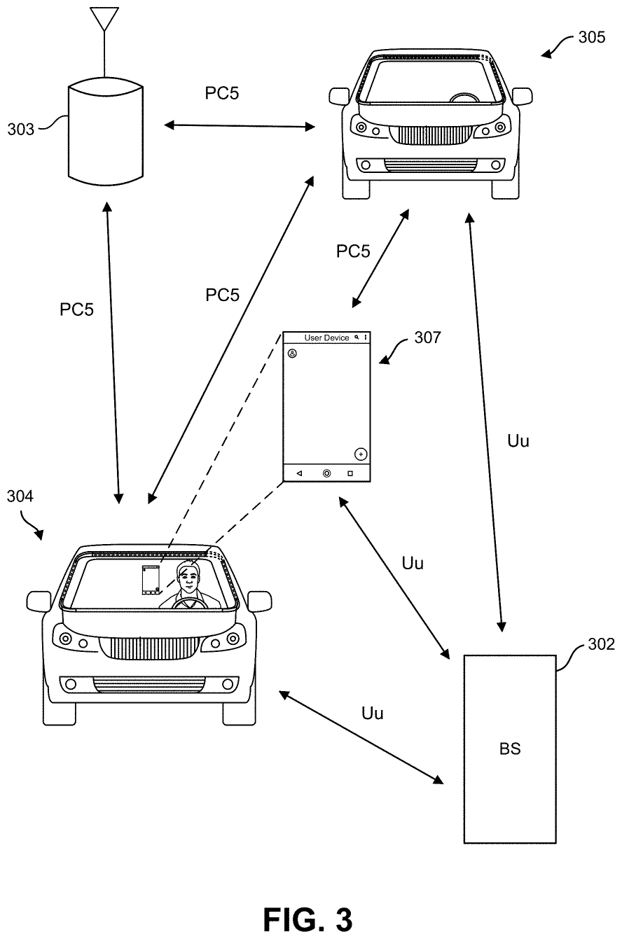

FIG. 3 illustrates examples of different communication mechanisms used by various UEs. In one example, FIG. 3 illustrates a vehicle 304, a vehicle 305, and a roadside unit (RSU) 303 that may communicate with each other using PC5 signaling interfaces. In addition, the vehicle 304 and the vehicle 305 may communicate with a base station 302 (shown as BS 302) using a network (Uu) interface. In some examples, the base station 302 may include a gNB (e.g., base stations 102). FIG. 3 also illustrates a user device 307 communicating with the base station 302 using a network (Uu) interface. In some aspects, functionalities may be transferred from a vehicle (e.g., vehicle 304) to a user device (e.g., user device 307) based on one or more characteristics or factors (e.g., temperature, humidity, etc.). In one illustrative example, V2X functionality may be transitioned from the vehicle 304 to the user device 307, after which the user device 307 may communicate with other vehicles (e.g., vehicle 305) over a PC5 interface, as shown in FIG. 3.

While PC5 interfaces are shown in FIG. 3, the various UEs (e.g., vehicles, user devices, etc.) and RSU(s) may communicate directly using any suitable type of direct interface, such as an 802.11 DSRC interface, a Bluetooth™ interface, and/or other interface. For example, a vehicle may communicate with a user device over a direct communications interface (e.g., using PC5 and/or DSRC), a vehicle may communicate with another vehicle over the direct communications interface, a user device may communicate with another user device over the direct communications interface, a UE (e.g., a vehicle, user device, etc.) may communicate with an RSU over the direct communications interface, an RSU may communicate with another RSU over the direct communications interface, and the like.

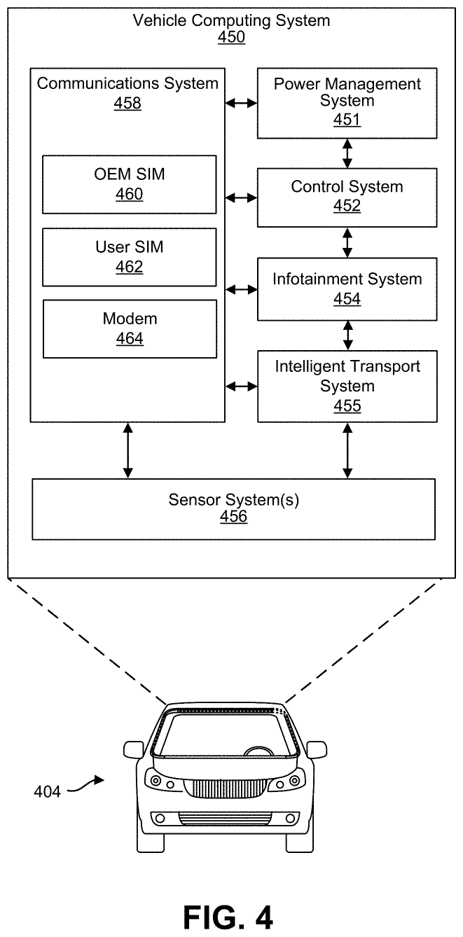

FIG. 4 is a block diagram illustrating an example vehicle computing system 450 of a vehicle 404. In some examples, the vehicle computing system 450 may be referred to as an on-board unit (OBU). The vehicle 404 is an example of a UE that may communicate with a network (e.g., an eNB, a gNB, a positioning beacon, a location measurement unit, and/or other network entity) over a Uu interface and with other UEs using V2X communications over a PC5 interface (or other device to device direct interface). As shown, the vehicle computing system 450 may include at least a power management system 451, a control system 452, an infotainment system 454, an intelligent transport system (ITS) 455, one or more sensor systems 456, and a communications system 458. In some cases, the vehicle computing system 450 may include or may be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 452 may be configured to control one or more operations of the vehicle 404, the power management system 451, the computing system 450, the infotainment system 454, the ITS 455, and/or one or more other systems of the vehicle 404 (e.g., a braking system, a steering system, a safety system other than the ITS 455, a cabin system, and/or other system). In some examples, the control system 452 may include one or more electronic control units (ECUs). An ECU may control one or more of the electrical systems or subsystems in a vehicle. Examples of specific ECUs that may be included as part of the control system 452 include an engine control module (ECM), a powertrain control module (PCM), a transmission control module (TCM), a brake control module (BCM), a central control module (CCM), a central timing module (CTM), among others. In some cases, the control system 452 may receive sensor signals from the one or more sensor systems 456 and may communicate with other systems of the vehicle computing system 450 to operate the vehicle 404.

The vehicle computing system 450 also includes a power management system 451. In some implementations, the power management system 451 may include a power management integrated circuit (PMIC), a standby battery, and/or other components. In some cases, other systems of the vehicle computing system 450 may include one or more PMICs, batteries, and/or other components. The power management system 451 may perform power management functions for the vehicle 404, such as managing a power supply for the computing system 450 and/or other parts of the vehicle. For example, the power management system 451 may provide a stable power supply in view of power fluctuations, such as based on starting an engine of the vehicle. In another example, the power management system 451 may perform thermal monitoring operations, such as by checking ambient and/or transistor junction temperatures. In another example, the power management system 451 may perform certain functions based on detecting a certain temperature level, such as causing a cooling system (e.g., one or more fans, an air conditioning system, etc.) to cool certain components of the vehicle computing system 450 (e.g., the control system 452, such as one or more ECUs), shutting down certain functionalities of the vehicle computing system 450 (e.g., limiting the infotainment system 454, such as by shutting off one or more displays, disconnecting from a wireless network, etc.), among other functions.

The vehicle computing system 450 further includes a communications system 458. The communications system 458 may include both software and hardware components for transmitting signals to and receiving signals from a network (e.g., a gNB or other network entity over a Uu interface) and/or from other UEs (e.g., to another vehicle or UE over a PC5 interface, WiFi interface, Bluetooth™ interface, and/or other wireless and/or wired interface). For example, the communications system 458 is configured to transmit and receive information wirelessly over any suitable wireless network (e.g., a 3G network, 4G network, 5G network, WiFi network, Bluetooth™ network, and/or other network). The communications system 458 includes various components or devices used to perform the wireless communication functionalities, including an original equipment manufacturer (OEM) subscriber identity module (referred to as a SIM or SIM card) 460, a user SIM 462, and a modem 464. While the vehicle computing system 450 is shown as having two SIMs and one modem, the computing system 450 may have any number of SIMs (e.g., one SIM or more than two SIMs) and any number of modems (e.g., one modem, two modems, or more than two modems) in some implementations.

A SIM is a device (e.g., an integrated circuit) that may securely store an international mobile subscriber identity (IMSI) number and a related key (e.g., an encryption-decryption key) of a particular subscriber or user. The IMSI and key may be used to identify and authenticate the subscriber on a particular UE. The OEM SIM 460 may be used by the communications system 458 for establishing a wireless connection for vehicle-based operations, such as for conducting emergency-calling (eCall) functions, communicating with a communications system of the vehicle manufacturer (e.g., for software updates, etc.), among other operations. The OEM SIM 460 may be used to support one or more services such as eCall for making emergency calls in the event of a car accident or other emergency. For instance, eCall may include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 462 may be used by the communications system 458 for performing wireless network access functions in order to support a user data connection (e.g., for conducting phone calls, messaging, Infotainment related services, among others). In some cases, a user device of a user may connect with the vehicle computing system 450 over an interface (e.g., over PCS, Bluetooth™, WiFI, a universal serial bus (USB) port, and/or other wireless or wired interface). Once connected, the user device may transfer wireless network access functionality from the user device to communications system 458 the vehicle, in which case the user device may cease performance of the wireless network access functionality (e.g., during the period in which the communications system 458 is performing the wireless access functionality). The communications system 458 may begin interacting with a base station to perform one or more wireless communication operations, such as facilitating a phone call, transmitting and/or receiving data (e.g., messaging, video, audio, etc.), among other operations. In such cases, other components of the vehicle computing system 450 may be used to output data received by the communications system 458. For example, the infotainment system 454 (described below) may display video received by the communications system 458 on one or more displays and/or may output audio received by the communications system 458 using one or more speakers.

A modem is a device that modulates one or more carrier wave signals to encode digital information for transmission, and demodulates signals to decode the transmitted information. The modem 464 (and/or one or more other modems of the communications system 458) may be used for communication of data for the OEM SIM 460 and/or the user SIM 462. In some examples, the modem 464 may include a 4G (or LTE) modem and another modem (not shown) of the communications system 458 may include a 5G (or NR) modem. In some examples, the communications system 458 may include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 464 (and/or one or more other modems of the communications system 458) may be used for performing V2X communications (e.g., with other vehicles for V2V communications, with other devices for D2D communications, with infrastructure systems for V2I communications, with pedestrian UEs for V2P communications, etc.). In some examples, the communications system 458 may include a V2X modem used for performing V2X communications (e.g., sidelink communications over a PC5 interface), in which case the V2X modem may be separate from one or more modems used for wireless network access functions (e.g., for network communications over a network/Uu interface and/or sidelink communications other than V2X communications).

In some examples, the communications system 458 may be or may include a telematics control unit (TCU). In some implementations, the TCU may include a network access device (NAD) (also referred to in some cases as a network control unit or NCU). The NAD may include the modem 464, any other modem not shown in FIG. 4, the OEM SIM 460, the user SIM 462, and/or other components used for wireless communications. In some examples, the communications system 458 may include a Global Navigation Satellite System (GNSS). In some cases, the GNSS may be part of the one or more sensor systems 456, as described below. The GNSS may provide the ability for the vehicle computing system 450 to perform one or more location services, navigation services, and/or other services that may utilize GNSS functionality.

In some cases, the communications system 458 may further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that may allow the vehicle 404 to communicate with a network and/or other UEs.

The vehicle computing system 450 may also include an infotainment system 454 that may control content and one or more output devices of the vehicle 404 that may be used to output the content. The infotainment system 454 may also be referred to as an in-vehicle infotainment (IVI) system or an In-car entertainment (ICE) system. The content may include navigation content, media content (e.g., video content, music or other audio content, and/or other media content), among other content. The one or more output devices may include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 404), and/or other output device.

In some examples, the computing system 450 may include the intelligent transport system (ITS) 455. In some examples, the ITS 455 may be used for implementing V2X communications. For example, an ITS stack of the ITS 455 may generate V2X messages based on information from an application layer of the ITS. In some cases, the application layer may determine whether certain conditions have been met for generating messages for use by the ITS 455 and/or for generating messages that are to be sent to other vehicles (for V2V communications), to pedestrian UEs (for V2P communications), and/or to infrastructure systems (for V2I communications). In some cases, the communications system 458 and/or the ITS 455 may obtain car access network (CAN) information (e.g., from other components of the vehicle via a CAN bus). In some examples, the communications system 458 (e.g., a TCU NAD) may obtain the CAN information via the CAN bus and may send the CAN information to the ITS stack. The CAN information may include vehicle related information, such as a heading of the vehicle, speed of the vehicle, breaking information, among other information. The CAN information may be continuously or periodically (e.g., every 1 millisecond (ms), every 10 ms, or the like) provided to the ITS 455.

The conditions used to determine whether to generate messages may be determined using the CAN information based on safety-related applications and/or other applications, including applications related to road safety, traffic efficiency, infotainment, business, and/or other applications. In one illustrative example, ITS 455 may perform lane change assistance or negotiation. For instance, using the CAN information, the ITS 455 may determine that a driver of the vehicle 404 is attempting to change lanes from a current lane to an adjacent lane (e.g., based on a blinker being activated, based on the user veering or steering into an adjacent lane, etc.). Based on determining the vehicle 404 is attempting to change lanes, the ITS 455 may determine a lane-change condition has been met that is associated with a message to be sent to other vehicles that are nearby the vehicle in the adjacent lane. The ITS 455 may trigger the ITS stack to generate one or more messages for transmission to the other vehicles, which may be used to negotiate a lane change with the other vehicles. Other examples of applications include forward collision warning, automatic emergency breaking, lane departure warning, pedestrian avoidance or protection (e.g., when a pedestrian is detected near the vehicle 404, such as based on V2P communications with a UE of the user), traffic sign recognition, among others.

The ITS 455 may use any suitable protocol to generate messages (e.g., V2X messages). Examples of protocols that may be used by the ITS 455 include one or more Society of Automotive Engineering (SAE) standards, such as SAE J2735, SAE J2945, SAE J3161, and/or other standards, which are hereby incorporated by reference in their entirety and for all purposes.

A security layer of the ITS 455 may be used to securely sign messages from the ITS stack that are sent to and verified by other UEs configured for V2X communications, such as other vehicles, pedestrian UEs, and/or infrastructure systems. The security layer may also verify messages received from such other UEs. In some implementations, the signing and verification processes may be based on a security context of the vehicle. In some examples, the security context may include one or more encryption-decryption algorithms, a public and/or private key used to generate a signature using an encryption-decryption algorithm, and/or other information. For example, each ITS message generated by the ITS stack may be signed by the security layer. The signature may be derived using a public key and an encryption-decryption algorithm. A vehicle, pedestrian UE, and/or infrastructure system receiving a signed message may verify the signature to make sure the message is from an authorized vehicle. In some examples, the one or more encryption-decryption algorithms may include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

In some examples, the ITS 455 may determine certain operations (e.g., V2X-based operations) to perform based on messages received from other UEs. The operations may include safety-related and/or other operations, such as operations for road safety, traffic efficiency, infotainment, business, and/or other applications. In some examples, the operations may include causing the vehicle (e.g., the control system 452) to perform automatic functions, such as automatic breaking, automatic steering (e.g., to maintain a heading in a particular lane), automatic lane change negotiation with other vehicles, among other automatic functions. In one illustrative example, a message may be received by the communications system 458 from another vehicle (e.g., over a PC5 interface) indicating that the other vehicle is coming to a sudden stop. In response to receiving the message, the ITS 455 may generate a message or instruction and may send the message or instruction to the control system 452, which may cause the control system 452 to automatically break the vehicle 404 so that it comes to a stop before making impact with the other vehicle. In other illustrative examples, the operations may include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

The computing system 450 further includes one or more sensor systems 456 (e.g., a first sensor system through an Nth sensor system, where N is a value equal to or greater than 0). When including multiple sensor systems, the sensor system(s) 456 may include different types of sensor systems that may be arranged on or in different parts the vehicle 404. The sensor system(s) 456 may include one or more camera sensor systems, Light Detection and Ranging (LIDAR) sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems may be included as part of the computing system 450 of the vehicle 404.

While the vehicle computing system 450 is shown to include certain components and/or systems, one of ordinary skill will appreciate that the vehicle computing system 450 may include more or fewer components than those shown in FIG. 4. For example, the vehicle computing system 450 may also include one or more input devices and one or more output devices (not shown). In some implementations, the vehicle computing system 450 may also include (e.g., as part of or separate from the control system 452, the infotainment system 454, the communications system 458, and/or the sensor system(s) 456) at least one processor and at least one memory having computer-executable instructions that are executed by the at least one processor. The at least one processor is in communication with and/or electrically connected to (referred to as being “coupled to” or “communicatively coupled”) the at least one memory. The at least one processor may include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory may include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory may be executed to perform one or more of the functions or operations described herein.

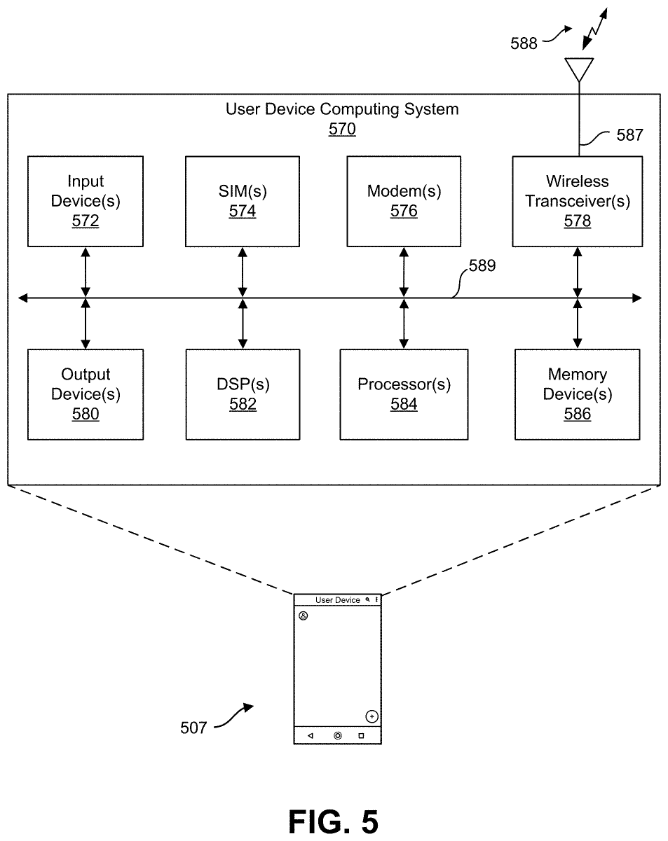

FIG. 5 illustrates an example of a computing system 570 of a wireless device 507. The wireless device 507 may include a client device such as a UE (e.g., UE 104, UE 152, UE 190) or other type of device (e.g., a station (STA) configured to communication using a Wi-Fi interface) that may be used by an end-user. Wireless device may also include network devices (e.g., base stations such as eNBs and/or gNBs, Wi-Fi access points (APs) such as routers, range extenders or the like, etc.). For example, the wireless device 507 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, base station, access point, and/or another device that is configured to communicate over a wireless communications network. The computing system 570 includes software and hardware components that may be electrically or communicatively coupled via a bus 589 (or may otherwise be in communication, as appropriate). For example, the computing system 570 includes one or more processors 584. The one or more processors 584 may include one or more CPUs, ASICs, FPGAs, APs, GPUs, VPUs, NSPs, microcontrollers, dedicated hardware, any combination thereof, and/or other processing device or system. The bus 589 may be used by the one or more processors 584 to communicate between cores and/or with the one or more memory devices 586.

The computing system 570 may also include one or more memory devices 586, one or more digital signal processors (DSPs) 582, one or more SIMs 574, one or more modems 576, one or more wireless transceivers 578, an antenna 587, one or more input devices 572 (e.g., a camera, a mouse, a keyboard, a touch sensitive screen, a touch pad, a keypad, a microphone, and/or the like), and one or more output devices 580 (e.g., a display, a speaker, a printer, and/or the like).

In some aspects, computing system 570 may include one or more radio frequency (RF) interfaces configured to transmit and/or receive RF signals. In some examples, an RF interface may include components such as modem(s) 576, wireless transceiver(s) 578, and/or antennas 587. The one or more wireless transceivers 578 may transmit and receive wireless signals (e.g., signal 588) via antenna 587 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 570 may include multiple antennas or an antenna array that may facilitate simultaneous transmit and receive functionality. Antenna 587 may be an omnidirectional antenna such that radio frequency (RF) signals may be received from and transmitted in all directions. The wireless signal 588 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 588 may be transmitted directly to other wireless devices using sidelink communications (e.g., using a PC5 interface, using a DSRC interface, etc.). Wireless transceivers 578 may be configured to transmit RF signals for performing sidelink communications via antenna 587 in accordance with one or more transmit power parameters that may be associated with one or more regulation modes. Wireless transceivers 578 may also be configured to receive sidelink communication signals having different signal parameters from other wireless devices.

In some examples, the one or more wireless transceivers 578 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 588 into a baseband or intermediate frequency and may convert the RF signals to the digital domain.

In some cases, the computing system 570 may include a coding-decoding device (or CODEC) configured to encode and/or decode data transmitted and/or received using the one or more wireless transceivers 578. In some cases, the computing system 570 may include an encryption-decryption device or component configured to encrypt and/or decrypt data (e.g., according to the AES and/or DES standard) transmitted and/or received by the one or more wireless transceivers 578.

The one or more SIMs 574 may each securely store an international mobile subscriber identity (IMSI) number and related key assigned to the user of the wireless device 507. The IMSI and key may be used to identify and authenticate the subscriber when accessing a network provided by a network service provider or operator associated with the one or more SIMs 574. The one or more modems 576 may modulate one or more signals to encode information for transmission using the one or more wireless transceivers 578. The one or more modems 576 may also demodulate signals received by the one or more wireless transceivers 578 in order to decode the transmitted information. In some examples, the one or more modems 576 may include a Wi-Fi modem, a 4G (or LTE) modem, a 5G (or NR) modem, and/or other types of modems. The one or more modems 576 and the one or more wireless transceivers 578 may be used for communicating data for the one or more SIMs 574.

The computing system 570 may also include (and/or be in communication with) one or more non-transitory machine-readable storage media or storage devices (e.g., one or more memory devices 586), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 586 and executed by the one or more processor(s) 584 and/or the one or more DSPs 582. The computing system 570 may also include software elements (e.g., located within the one or more memory devices 586), including, for example, an operating system, device drivers, executable libraries, and/or other code, such as one or more application programs, which may comprise computer programs implementing the functions provided by various embodiments, and/or may be designed to implement methods and/or configure systems, as described herein.

In some aspects, the wireless device 507 may include means for performing operations described herein. The means may include one or more of the components of the computing system 570. For example, the means for performing operations described herein may include one or more of input device(s) 572, SIM(s) 574, modems(s) 576, wireless transceiver(s) 578, output device(s) (580), DSP(s) 582, processors (584), memory device(s) 586, and/or antenna(s) 587.

In some aspects, wireless device 507 may correspond to a user equipment (UE) and may include: means for receiving positioning data corresponding to a second UE; means for determining a relative position between the UE and the second UE; and means for determining a first location of the UE based on the positioning data corresponding to the second UE and the relative position between the UE and the second UE. In some examples, the means for receiving may include the one or more wireless transceivers 578, the one or more modems 576, the one or more SIMs 574, the one or more processors 584, the one or more DSPs 582, the one or more memory devices 586, any combination thereof, or other component(s) of the wireless device. In some aspects, the means for determining may include the one or more processors 584, the one or more DSPs 582, the one or more wireless transceivers 578, the one or more modems 576, the one or more memory devices 586, any combination thereof, or other component(s) of the wireless device.

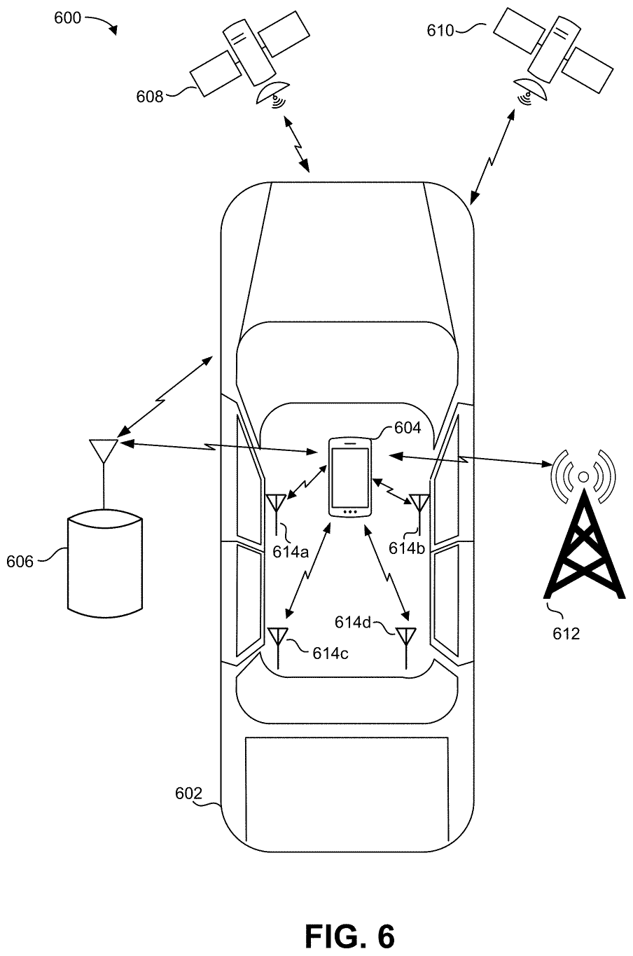

As noted previously, systems and techniques are described herein for performing user equipment (UE) coordinated positioning. FIG. 6 is a diagram illustrating an example wireless communications system 600 for implementing coordinated positioning among UEs. In some aspects, the system 600 may include a vehicle UE such as vehicle 602. In some cases, the system 600 may include a pedestrian UE such as UE 604. As noted above, UE 604 may include any wireless communication device (e.g., a mobile phone, router, tablet computer, laptop computer, tracking device, wearable device (e.g., smart watch, glasses, an extended reality (XR) device such as a virtual reality (VR) headset, an augmented reality (AR) headset or glasses, or a mixed reality (MR) headset, etc.), Internet of Things (IoT) device, etc.) used by a user to communicate over a wireless communications network.

In some cases, UE 604 may be located within vehicle 602. Alternatively, in some aspects, UE 604 may be located outside vehicle 602 or in a different vehicle. Although FIG. 6 is illustrated using a pedestrian UE (e.g., UE 604) and a vehicle UE (e.g., vehicle 602), those skilled in the art will recognize that UE coordinated positioning may be implemented among any combination of UEs and/or with any number of UEs. In some aspects, vehicle 602 and UE 604 may communicate each other using sidelink communications (e.g., PC5, DSRC, etc.), Bluetooth™, WiFi, NFC, Ultra-Wide Band (UWB), Universal Serial Bus (USB), using any other suitable wireless or wired communications protocol, and/or any combination thereof.

In some examples, system 600 may include one or more road side units (RSUs) such as RSU 606. In some cases, RSU 606 may correspond to a stationary device with known location (SDKL). In some aspects, vehicle 602 and/or UE 604 may communicate with RSU 606 using sidelink communications, UWB, Bluetooth™, and/or any other suitable communications protocol. In some configurations, system 600 may also include a base station 612 that may be associated with UE 604 (e.g., UE 604 may communicate with base station 612 using a network (Uu) interface). In some aspects, system 600 may include one or more Global Navigation Satellite System (GNSS) satellites such as satellite 608 and satellite 610. In some cases, vehicle 602 and/or UE 604 may communicate with satellite 608 and/or satellite 610 to perform geolocation.

In some aspects, vehicle 602 and UE 604 can be configured to perform UE coordinated positioning. In some cases, UE coordinated positioning may be configured using a software application (e.g., mobile application or native application), software settings, an operating system, vehicle software, user profiles, etc. In some examples, UE coordinated positioning can be used by a UE (e.g., vehicle 602 or UE 604) to calculate an absolute position based on position data received from another UE (e.g., vehicle 602 or UE 604). In some cases, UE coordinated positioning can be used to enhance positioning accuracy of a UE. In some examples, UE coordinated positioning can be used when a vehicle (e.g., vehicle 602) is capable of implementing high accuracy positioning that can be used to improve the positioning accuracy of a pedestrian UE (e.g., UE 604). For instance, vehicle 602 can provide (e.g., send, transmit, etc.) positioning data to UE 604. In some examples, UE 604 can determine a relative position to vehicle 602 and use the positioning data from vehicle 602 to calculate an absolute position (e.g., position estimate) for UE 604. In some cases, the pedestrian UE (e.g., UE 604) may save power by leveraging position data from the vehicle (e.g., vehicle 602) and limiting use of a local GNSS receiver. In another example, a UE (e.g., UE 604) may use coordinated positioning when a GNSS signal is not available and/or when the accuracy of a geolocation is below a threshold value.

In some aspects, UE coordinated positioning can be used when a pedestrian UE (e.g., UE 604) is capable of implementing high accuracy positioning that can be used to improve the positioning accuracy of a vehicle UE (e.g., vehicle 602). For example, a pedestrian UE (e.g., UE 604) may have updated software and/or hardware relative to a vehicle (e.g., vehicle 602). In some cases, the updated hardware and/or software in a pedestrian UE may yield higher position accuracy than can be achieved by a vehicle UE. In some examples, UE 604 can provide (e.g., send, transmit, etc.) positioning data to vehicle 602. In some cases, vehicle 602 can determine a relative position to UE 604 and use the positioning data from UE 604 to calculate an absolute position for vehicle 602.

As noted above, vehicle 602 and UE 604 may use UE coordinated positioning to determine and/or improve absolute position. For instance, UE 604 may be in a place where UE 604 cannot access a GNSS signal and/or UE 604 cannot obtain a requisite level of positioning accuracy. In some aspects, UE 604 may use position data from vehicle 602 to calculate an absolute position for UE 604. In some cases, UE 604 may derive an absolute position for UE 604 by determining a relative position between UE 604 and vehicle 602. In some examples, the relative position between UE 604 and vehicle 602 can be determined using relative positioning techniques such as ultra-wideband (UWB), wireless wide area network (WWAN) (e.g., 5G NR mmW, 5G/6G D2D, PC 5, 60 GHz mmW, WiFi, camera sensors, and/or any combination thereof.

In some aspects, vehicle 602 may have one or more antennas (e.g., UWB antenna 614a, UWB antenna 614b, UWB antenna 614c, and/or UWB antenna 614d) that can be used to determine relative positioning between vehicle 602 and UE 604. In some examples, UWB antennas 614 can be associated with a pre-determined location relative to the center of vehicle 602 and/or relative to a GNSS antenna. In some cases, UWB antennas 614 can be used to transmit and/or receive radio frequency (RF) signals to UE 604. In some example, UE 604 may also include one or more UWB antennas (not illustrated).

In some cases, UWB signals transmitted and received by vehicle 602 and/or UE 604 can be used to determine relative positioning between vehicle 602 and UE 604. For example, vehicle 602 and/or UE 604 can determine a distance between vehicle 602 and UE 604 by measuring the difference in time from transmission to reception of an RF signal. For example, the distance can be determined by determining the difference from the time that vehicle 602 transmitted a UWB signal to the time UE 604 received the UWB signal.

In another example, the angle of arrival can be determined by measuring the phase difference of arrival (PDOA) and/or time difference of arrival (TDOA) of a UWB signal between individual elements of an antenna array. For instance, UWB antennas 614 can be used to determine an angle of arrival (AoA) of a UWB signal based on a relative delay in the arrival of the UWB signal at a corresponding antenna. In some aspects, UE 604 may have multiple UWB antennas that can determine the AOA of signals transmitted by UWB antennas 614 on vehicle 602. In some examples, the distance between vehicle 602 and UE 604 and the angle of arrival of one or more UWB signals can be used to determine a relative position between vehicle 602 and UE 604. In some aspects, the distance between vehicle 602 and UE 604 can be determined within +/−10 cm of accuracy. In some instances, the AoA of a signal may be determined within +/−3° level of accuracy.

In some examples, vehicle 602 may determine its absolute position (e.g., geolocation) based on signals received from one or more GNSS satellites (e.g., satellite 608 and/or satellite 610). In some instances, vehicle 602 may determine its absolute position based on signals received from a wireless wide area network (WWAN) (e.g., a 4G network, a 5G network, etc.). In some cases, vehicle 602 can send position data to UE 604 that includes the absolute position (e.g., latitude and longitude data) of vehicle 602. In some examples, sharing position data that includes the absolute position can be referred to as loose coupling (e.g., position level coupling). In some cases, vehicle 602 can send position data to UE 604 that includes raw data, measurements, and/or readings obtained from one or more satellites or position sensors. For instance, vehicle 602 can send position data that includes the data obtained from satellite 608, satellite 610, and/or any combination thereof. In some examples, sharing position data that includes measurement data can be referred to as tight coupling (e.g., measurement level coupling).

In some aspects, vehicle 602 can send position data to UE 604. In some cases, vehicle 602 can also send UE 604 an accuracy estimate that is associated with the position data. In some examples, UE 604 can calculate its absolute position based on the position data from vehicle 602 and the relative positioning between vehicle 602 and UE 604. For instance, UE 604 can calculate an absolute position by adjusting position data from vehicle 602 by a delta corresponding to the relative position between vehicle 602 and UE 604 (e.g., performing vector addition).

In some examples, UE 604 may compare the calculated position (e.g., based on position data from vehicle 602) with a locally derived position (e.g., based on local GNSS data). In some cases, UE 604 may compare the accuracy of the calculated position with the accuracy of the locally derived position. In some configurations, UE 604 may determine that a delta between the calculated position and the locally derived position exceeds a threshold value. In some aspects, UE 604 may select the position estimate (e.g., calculated vs. local) that has a higher level of accuracy (e.g., when the delta exceeds a threshold value). In some cases, UE 604 may combine the two position estimates using a weighted combination that can be based on a corresponding accuracy metric or estimate. In some aspects, UE 604 may process the position estimates and/or the accuracy estimates using a position multi-sensor fusion engine (e.g., Kalman filter, machine learning algorithm, etc.).

In some aspects, vehicle 602 and/or UE 604 may perform UE coordinated positioning with data exchange (e.g., share data between vehicle 602 and UE 604). In some cases, the data can include real-time kinematic (RTK) positioning data that can be used to correct errors associated with GNSS measurements. In some instances, the data can include any type of data that can be used to improve positioning estimates. In one example, UE 604 may have network access through base station 612 while vehicle 602 may be outside of a coverage area. In another example, vehicle 602 may not be configured to access a data network (e.g., expired subscription). In some aspects, UE 604 may obtain and generate data that can be used by vehicle 602 to improve positioning estimates. In some examples, the data can be shared between vehicle 602 and UE 604 using any suitable communications protocol (e.g., Bluetooth™, WiFi, USB, etc.).

In some cases, the RTK data can be modified based on UE relative positioning data. For example, vehicle 602 may determine that UE 604 is located in a place where UE 604 does not have line-of-sight to satellite 608. In some aspects, vehicle 602 may remove RTK data associated with satellite 608 and provide RTK data associated with satellite 610 (e.g., visible to UE 604 base on position estimate).

In some aspects, UE coordinated positioning can be used in connection with public transportation. For example, vehicle 602 may correspond to a public transportation vehicle such as a bus, subway, train, airplane, etc. In some examples, a pedestrian UE (e.g., UE 604) travelling within a public transportation vehicle may not be able to obtain a geolocation because GNSS signal may be unavailable (e.g., subway underground, bus travelling through urban canyon, etc.). In some cases, UE 604 may use UE coordinated positioning to communicate with vehicle 602 and to calculate geolocation. For instance, a subway (e.g., vehicle 602) may send location data to UE 604 that is based on a subway management system. In some aspects, the subway may be equipped with UWB transceivers that can be used to perform relative positioning with UE 604.

In some aspects, the public transportation vehicle (e.g., vehicle 602) may send periodic position updates to the UE (e.g., UE 604). In some cases, the public transportation vehicle may send position updates in response to a query from a UE. In some examples, the UE may be equipped with a mobile application that can be used to configure UE coordinated positioning with the public transportation vehicle. In some instances, additional settings can be configured to provide alerts to the UE (e.g., arrival, departure, etc.) In some cases, UE coordinated positioning can be used to direct a user to the correct public transportation vehicle. For example, UE 604 can use UE coordinated positioning to identify the location of a train and direct a user to board the correct train.

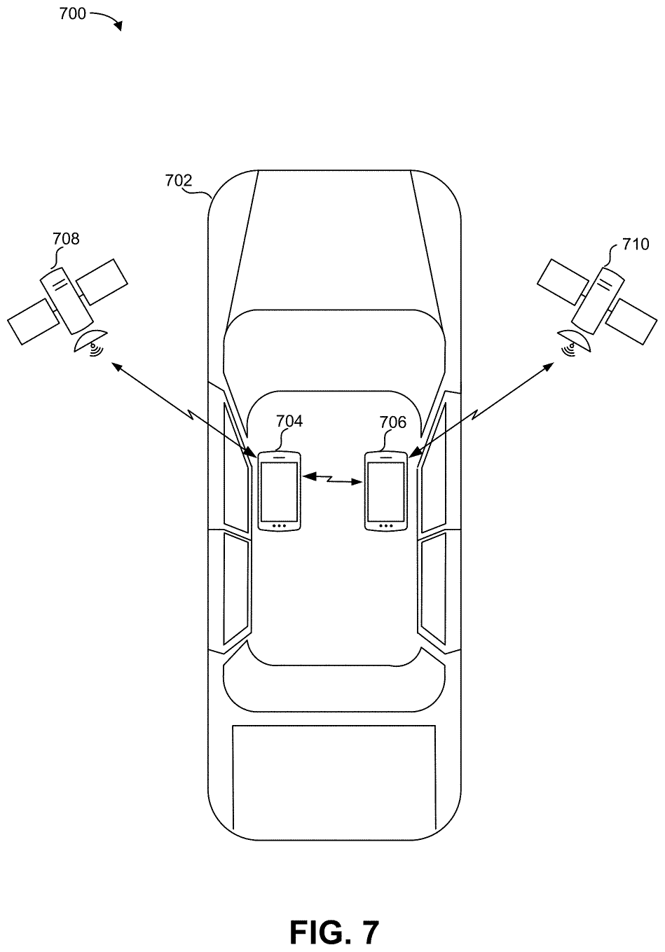

FIG. 7 is a diagram illustrating an example wireless communications system 700 for implementing coordinated positioning among UEs. In some aspects, the system 700 may include a vehicle UE such as vehicle 702. In some cases, the system 700 may include one or more pedestrian UEs such as UE 704 and UE 706.

In some examples, UE 704 and UE 706 may be located within vehicle 702. In some aspects, UE 704 may be located on a left side of vehicle 702 with access to satellite 708. In some configurations, UE 706 may be located on a right side of vehicle 702 with access to satellite 710. As illustrated, UE 704 may not have access to satellite 710 and UE 706 may not have access to satellite 708.

In some cases, UE 704 and UE 706 may be configured to perform UE coordinated positioning. For example, UE 704 may obtain GNSS measurements from satellite 708 and provide the position data (e.g., tight coupling or measurement level coupling) to UE 706. In some cases, UE 706 may obtain GNSS measurements from satellite 710 and provide the position data (e.g., tight coupling or measurement level coupling) to UE 704.

In some aspects, UE 704 and UE 706 can use ultra-wideband (UWB) signaling to determine relative positioning (e.g., position of UE 704 relative to UE 706 and vice-versa). In some examples, UE 704 and UE 706 can use relative positioning to share and utilize measurements from satellites that are obstructed or inaccessible to a respective UE. For instance, UE 704 can use relative positioning to adjust the GNSS measurements received from UE 706 (e.g., associated with satellite 710). In some cases, by applying a delta corresponding to the relative positioning, UE 704 can use the GNSS measurements from satellite 710 to determine its geolocation. In another example, UE 706 can use relative positioning to adjust the GNSS measurements received from UE 704 (e.g., associated with satellite 708). In some aspects, UE 706 can apply a delta to the measurements from UE 704 in order to use data from satellite 708 to determine its geolocation.

In some cases, UE 704 and/or UE 706 may also perform relative positioning with vehicle 702. For example, vehicle 702 may be configured to transmit and/or receive UWB signals to determine a relative position of UE 704 and/or UE 706. As discussed with respect to FIG. 6, vehicle 702 may send or receive position data from UE 704 and/or UE 706 to improve location estimation.

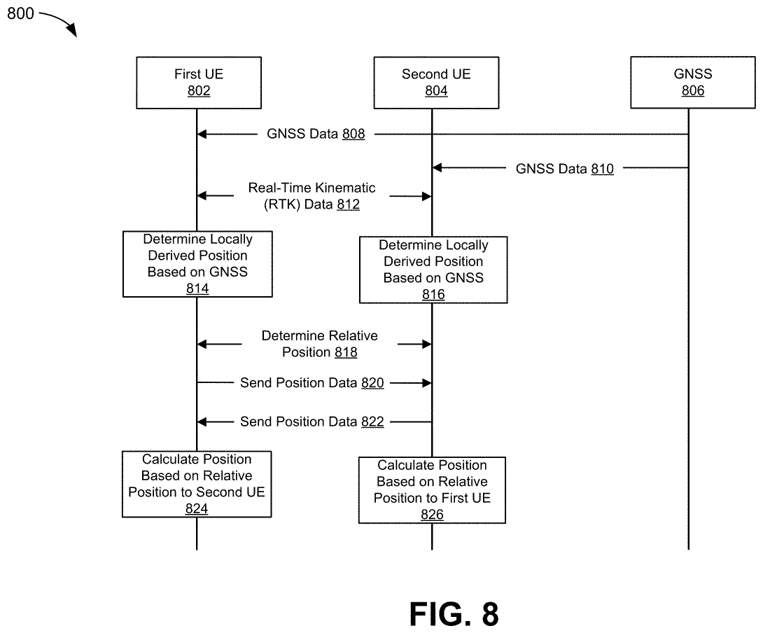

FIG. 8 is a sequence diagram illustrating an example of a sequence 800 for performing UE coordinated positioning. The sequence 800 may be performed by a first UE 802, a second UE 804, and a Global Navigation Satellite System (GNSS) 806. In some cases, the first UE can correspond to a pedestrian UE (e.g., mobile phone, tablet, etc.) In some examples, the second UE can correspond to a vehicle UE (e.g., car, bus, public transportation vehicle, etc.) At action 808, first UE 802 may obtain positioning data from GNSS 806. At action 810, second UE 804 may obtain positioning data from GNSS 806. At action 812, first UE 802 and/or second UE 804 may send and/or receive real-time kinematic (RTK) data. For example, first UE 802 may obtain RTK data from a data network and provide it to second UE 804. In some aspects, second UE 804 may use the RTK data to adjust or correct one or more GNSS measurements. In another example, second UE 804 may obtain RTK data from a data network and provide it to first UE 802. In some cases, first UE 802 may use the RTK data to adjust or correct one or more GNSS measurements.

At action 814, first UE 802 may use the positioning data from GNSS 806 to determine its geolocation (e.g., locally derived position). At action 816, second UE 804 may use the positioning data from GNSS 806 to determine its geolocation (e.g., locally derived position). At action 818, first UE 802 and second UE 804 can perform relative positioning. In some aspects, relative positioning can be performed using ultra-wideband (UWB) signaling. For example, first UE 802 and/or second UE 804 can transmit and/or receive UWB signals that can be used to determine a distance (e.g., based on time of flight) between first UE 802 and second UE 804. In some cases, first UE 802 and/or second UE 804 can transmit and/or receive UWB signals that can be used to determine a direction (e.g., based on angle of arrival) between first UE 802 and second UE 804.

At action 820, first UE 802 can send position data to second UE 804. In some examples, the position data can include the absolute position (e.g., position level coupling or loose coupling) of first UE 802 as determined by first UE 802 based on GNSS measurements from GNSS 806. In some cases, the position data can include measurements or data obtained by first UE 802 from GNSS 806 (e.g., measurement level coupling or tight coupling). In some examples, the measurements can include measurements obtained from one or more GNSS satellites that are not accessible to the second UE 804.

At action 822, second UE 804 can send position data to first UE 804. In some examples, the position data can include the absolute position (e.g., position level coupling or loose coupling) of second UE 804 as determined by second UE 804 based on GNSS measurements from GNSS 806. In some cases, the position data can include measurements or data obtained by second UE 804 from GNSS 806 (e.g., measurement level coupling or tight coupling). In some examples, the measurements can include measurements obtained from one or more GNSS satellites that are not accessible to the first UE 802. In some cases, the position data from first UE 802 and/or from second UE 804 can include an accuracy metric. For instance, second UE 804 can determine that its calculated position (e.g., latitude and longitude) is accurate to within +/−5 meters.

At action 824, first UE 802 may calculate a position based on its position relative to second UE 804. For example, first UE 802 can calculate a position by adjusting the position data received from second UE 804 based on the position of first UE 802 relative to second UE 804. In one illustrative example, first UE 802 can determine based on relative positioning that first UE 802 is located two feet directly to the left of second UE 804. In some aspects, first UE 802 can calculate its position by adjusting the location data received from second UE 804 to be two feet to the left.

In some examples, first UE 802 may compare a locally derived position (e.g., based on local GNSS data) with a position calculated based on relative positioning. In some cases, first UE 802 may select the position estimate (e.g., calculated vs. local) that has a higher level of accuracy when the delta between the estimated positions exceeds a threshold value).

At action 826, second UE 804 may calculate a position based on its position relative to first UE 802. For example, second UE 804 can calculate a position by adjusting the position data received from first UE 802 based on the position of second UE 804 relative to first UE 802. In some aspects, adjusting the position data can include adjusting the absolute position received from first UE 802 (e.g., loose coupling). In some cases, adjusting the position data can include adjusting one or more measurements received from first UE 802 (e.g., tight coupling).

In some examples, first UE 802 and/or second UE 804 may repeat one or more of the steps in sequence 800 periodically. For example, first UE 802 and second UE 804 may perform relative positioning and/or exchange position data every 30 seconds. In some aspects, first UE 802 may correspond to a pedestrian UE and second UE 804 may correspond to a vehicle. In some cases, relative positioning may not be repeated while first UE 802 (e.g., pedestrian UE) is located within the second UE 804 (e.g., vehicle). In some aspects, movement of a pedestrian UE can be detected based on UE sensors (e.g., gyroscope, accelerometer, etc.). In some cases, movement of a pedestrian UE can be used to trigger relative positioning (e.g., using UWB).

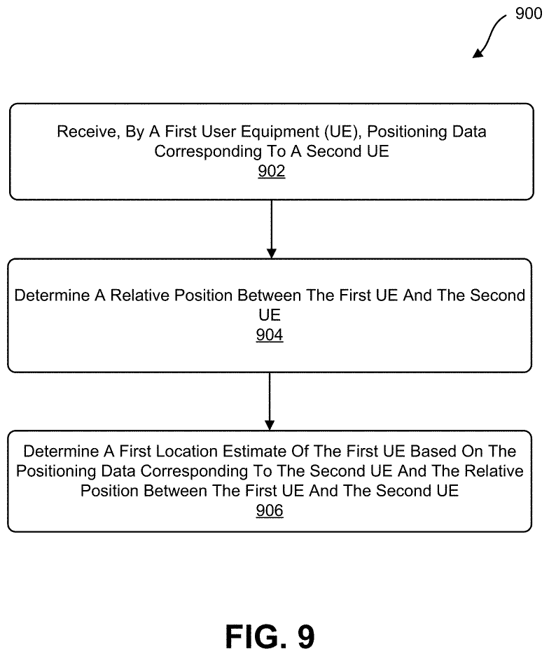

FIG. 9 is a flow diagram illustrating an example of a process 900 for performing user equipment coordinated positioning. At block 902, the process 900 includes receiving, by a first user equipment (UE), positioning data corresponding to a second UE. For example, UE 604 can receive positioning data corresponding to vehicle 602. In some aspects, the positioning data can include an absolute position of the second UE. For instance, vehicle 602 can send positioning data to UE 604 that includes the absolute position of vehicle 602. In some cases, the positioning data can include one or more sensor measurements performed by the second UE. For example, vehicle 602 can send positioning data to UE 604 that includes one or more sensor measurements performed by vehicle 602. In some examples, the one or more sensor measurements can include at least one of Global Navigation Satellite System (GNSS) measurements and wireless wide area network (WWAN) measurements. For example, the one or more measurements performed by vehicle 602 can include GNSS measurements, WWAN measurements, etc.

At block 904, the process 900 includes determining a relative position between the first UE and the second UE. For example, UE 604 may determine a relative position between UE 604 and vehicle 602. In some aspects, determining the relative position between the first UE and the second UE may include determining, based on a radio frequency (RF) signal, a time of flight and an angle of arrival between the first UE and the second UE. For example, UE 604 may determine a relative position between UE 604 and vehicle 602 based on one or more RF signals transmitted/received among UE 604 and vehicle 602. For instance, vehicle 602 may use antennas 614 to transmit one or more RF signals that can be received by UE 604. In some cases, UE 604 may determine a time of flight and/or angle of arrival of the RF signal(s) in order to determine the relative position between UE 604 and vehicle 602. In some examples, the RF signal may include at least one of an ultra-wideband (UWB) signal, a 5G mmW signal, and a PC5 signal.

At block 906, the process 900 includes determining a first location estimate of the first UE based on the positioning data corresponding to the second UE and the relative position between the first UE and the second UE. For example, UE 604 can determine a first location estimate (e.g., a geolocation estimate) of UE 604 based on the positioning data received from vehicle 602 and the relative position between UE 604 and vehicle 602. In some examples, the first UE may correspond to a pedestrian UE and the second UE may correspond to a vehicle UE. For instance, the first UE may correspond to UE 604 and the second UE may correspond to vehicle 602. In some aspects, the second UE may correspond to a public transportation vehicle. For example, vehicle 602 may correspond to a public transportation vehicle such as a bus, subway, train, airplane, etc.

In some cases, the process 900 may include determining a second location estimate of the first UE based on one or more sensor measurements performed by the first UE and sending the second location estimate of the first UE to the second UE. For example, UE 604 may determine a second location estimate of UE 604 based on measurements (e.g., GNSS measurements, WWAN measurements, etc.) performed by UE 604. In some cases, UE 604 may send the second location estimate to vehicle 602.

In some examples, the process 900 can include determining a first accuracy estimate associated with the first location estimate and a second accuracy estimate associated with the second location estimate. For instance, UE 604 may determine a first accuracy estimate associated with the first location estimate (e.g., based on relative positioning with vehicle 602) and a second accuracy estimate associated with the second location estimate (e.g., based on measurements made by UE 604). In some cases, the process 900 can include selecting at least one of the first location estimate and the second location estimate based on a comparison of the first accuracy estimate and the second accuracy estimate. For example, UE 604 may select the first location estimate or the second location estimate based on a corresponding accuracy estimate. In some cases, UE 604 may select the location estimate associated with a higher level of accuracy (e.g., based on the accuracy estimates).

In some aspects, the process 900 can include determining a third location estimate of the first UE based on a weighted combination of the first location estimate and the second location estimate, wherein the weighted combination is based on the first accuracy estimate and the second accuracy estimate. For example, UE 604 may determine a third location estimate of the UE 604 that is based on a weighted combination (e.g., weighed average) of the first location estimate and the second location estimate. In some cases, UE 604 can use the first accuracy estimate and the second accuracy estimate to adjust weights in the weighted combination.

In some instances, the process 900 can include obtaining real-time kinematic (RTK) data associated with the positioning data corresponding to the second UE and sending the RTK data to the second UE. For instance, UE 604 may obtain RTK data (e.g., via base station 612) associated with the positioning data corresponding to vehicle 602. In some cases, UE 604 can use the RTK data to adjust or modify the positioning data received from vehicle 602. In some aspects, UE 604 may send the RTK data to vehicle 602.

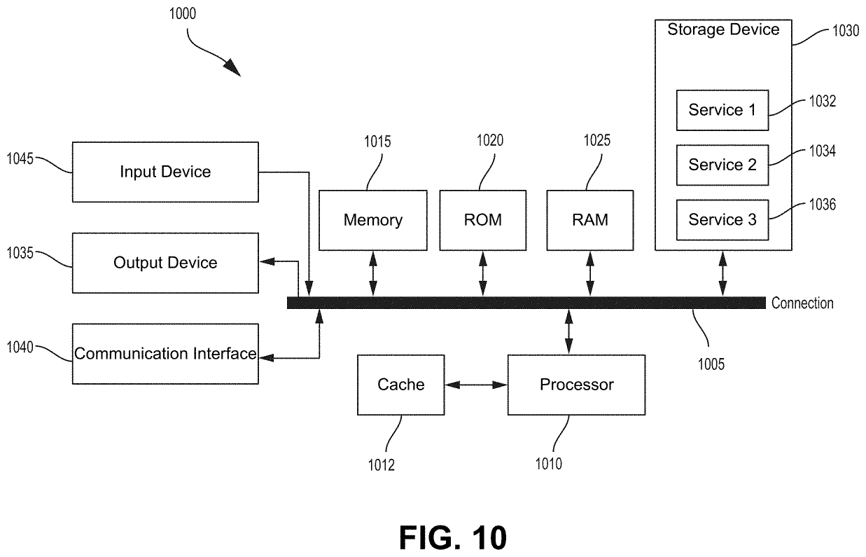

In some examples, the processes described herein (e.g., process 900 and/or other process described herein) may be performed by a computing device or apparatus (e.g., a UE, a base station, etc.). In one example, the process 900 may be performed by a wireless communication device, such as a UE (e.g., the vehicle 404 of FIG. 4, a mobile device, and/or other UE or device). In another example, the process 900 may be performed by a computing device with the computing system 1000 shown in FIG. 10. For instance, a wireless communication device (e.g., the vehicle 404 of FIG. 4, mobile device, and/or other UE or device) with the computing architecture shown in FIG. 10 may include the components of the UE and may implement the operations of FIG. 9.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 900 is illustrated as logical flow diagrams, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 900 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a diagram illustrating an example of a system for implementing certain aspects of the present technology. In particular, FIG. 10 illustrates an example of computing system 1000, which may be for example any computing device making up internal computing system, a remote computing system, a camera, or any component thereof in which the components of the system are in communication with each other using connection 1005. Connection 1005 may be a physical connection using a bus, or a direct connection into processor 1010, such as in a chipset architecture. Connection 1005 may also be a virtual connection, networked connection, or logical connection.

In some embodiments, computing system 1000 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 may include a cache 1012 of high-speed memory connected directly with, in close proximity to, or integrated as part of processor 1010.

Processor 1010 may include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms. In some instances, multimodal systems may enable a user to provide multiple types of input/output to communicate with computing system 1000.

Computing system 1000 may include communications interface 1040, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON′ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 may include software services, servers, services, etc., that when the code that defines such software is executed by the processor 1010, it causes the system to perform a function. In some embodiments, a hardware service that performs a particular function may include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. As an example, claim language reciting “at least one of: A, B, or C” is intended to cover A, B, C, A-B, A-C, B-D, and A-B-C, as well as any combination with multiples of the same element (e.g., A-A, A-A-A, A-A-B, A-A-C, A-B-B, A-C-C, B-B, B-B-B, B-B-C, C-C, and C-C-C or any other ordering of A, B, and C). The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method for wireless communications performed at a first user equipment (UE), comprising: receiving positioning data corresponding to a second UE; determining a relative position between the first UE and the second UE; and determining a first location estimate of the first UE based on the positioning data corresponding to the second UE and the relative position between the first UE and the second UE.

Aspect 2. The method of Aspect 1, wherein the positioning data includes an absolute position of the second UE.

Aspect 3. The method of any of Aspects 1 to 2, wherein the positioning data includes one or more sensor measurements performed by the second UE.

Aspect 4. The method of Aspect 3, wherein the one or more sensor measurements include at least one of Global Navigation Satellite System (GNSS) measurements and wireless wide area network (WWAN) measurements.

Aspect 5. The method of any of Aspects 1 to 4, wherein determining the relative position between the first UE and the second UE comprises: determining, based on a radio frequency (RF) signal, a time of flight and an angle of arrival between the first UE and the second UE.

Aspect 6. The method of Aspect 5, wherein the RF signal includes at least one of an ultra-wideband (UWB) signal, a 5 G mmW signal, and a PC5 signal.

Aspect 7. The method of any of Aspects 1 to 6, wherein the first UE corresponds to a pedestrian UE and the second UE corresponds to a vehicle UE.

Aspect 8. The method of any of Aspects 1 to 7, further comprising: determining a second location estimate of the first UE based on one or more sensor measurements performed by the first UE; and sending the second location estimate of the first UE to the second UE.

Aspect 9. The method of Aspect 8, further comprising: determining a first accuracy estimate associated with the first location estimate and a second accuracy estimate associated with the second location estimate.

Aspect 10. The method of Aspect 9, further comprising: selecting at least one of the first location estimate and the second location estimate based on a comparison of the first accuracy estimate and the second accuracy estimate.

Aspect 11. The method of any of Aspects 9 to 10, further comprising: determining a third location estimate of the first UE based on a weighted combination of the first location estimate and the second location estimate, wherein the weighted combination is based on the first accuracy estimate and the second accuracy estimate.

Aspect 12. The method of any of Aspects 1 to 11, further comprising: obtaining real-time kinematic (RTK) data associated with the positioning data corresponding to the second UE; and sending the RTK data to the second UE.

Aspect 13. The method of any of Aspects 1 to 12, wherein the second UE corresponds to a public transportation vehicle.

Aspect 14. An apparatus for wireless communications, comprising: at least one memory; and at least one processor coupled to the at least one memory, wherein the at least one processor is configured to perform operations in accordance with any one of Aspects 1-13.

Aspect 15. An apparatus for wireless communications, comprising means for performing operations in accordance with any one of Aspects 1 to 13.

Aspect 16: A non-transitory computer-readable medium comprising instructions that, when executed by an apparatus, cause the apparatus to perform operations in accordance with any one of Aspects 1 to 13.

What is claimed is:

1. A method for wireless communications performed at a first user equipment (UE), comprising:
receiving positioning data corresponding to a second UE;
determining a relative position between the first UE and the second UE; and
determining a first location estimate of the first UE based on the positioning data corresponding to the second UE and the relative position between the first UE and the second UE.

2. The method of claim 1, wherein the positioning data includes an absolute position of the second UE.

3. The method of claim 1, wherein the positioning data includes one or more sensor measurements performed by the second UE.

4. The method of claim 3, wherein the one or more sensor measurements include at least one of Global Navigation Satellite System (GNSS) measurements and wireless wide area network (WWAN) measurements.

5. The method of claim 1, wherein determining the relative position between the first UE and the second UE comprises:
determining, based on a radio frequency (RF) signal, a time of flight and an angle of arrival between the first UE and the second UE.

6. The method of claim 5, wherein the RF signal includes at least one of an ultra-wideband (UWB) signal, a 5G mmW signal, and a PC5 signal.

7. The method of claim 1, wherein the first UE corresponds to a pedestrian UE and the second UE corresponds to a vehicle UE.

8. The method of claim 1, further comprising:
determining a second location estimate of the first UE based on one or more sensor measurements performed by the first UE; and
sending the second location estimate of the first UE to the second UE.

9. The method of claim 8, further comprising:
determining a first accuracy estimate associated with the first location estimate and a second accuracy estimate associated with the second location estimate.

10. The method of claim 9, further comprising:
selecting at least one of the first location estimate and the second location estimate based on a comparison of the first accuracy estimate and the second accuracy estimate.

11. The method of claim 9, further comprising:
determining a third location estimate of the first UE based on a weighted combination of the first location estimate and the second location estimate, wherein the weighted combination is based on the first accuracy estimate and the second accuracy estimate.

12. The method of claim 1, further comprising:
obtaining real-time kinematic (RTK) data associated with the positioning data corresponding to the second UE; and
sending the RTK data to the second UE.

13. The method of claim 1, wherein the second UE corresponds to a public transportation vehicle.

14. An apparatus for wireless communications, comprising:
at least one memory; and
at least one processor coupled to the memory and configured to:
receive positioning data corresponding to a user equipment (UE);
determine a relative position between the apparatus and the UE; and
determine a first location estimate of the apparatus based on the positioning data corresponding to the UE and the relative position between the apparatus and the UE.

15. The apparatus of claim 14, wherein the positioning data includes an absolute position of the UE.

16. The apparatus of claim 14, wherein the positioning data includes one or more sensor measurements performed by the UE.

17. The apparatus of claim 16, wherein the one or more sensor measurements include at least one of Global Navigation Satellite System (GNSS) measurements and wireless wide area network (WWAN) measurements.

18. The apparatus of claim 14, wherein to determine the relative position between the apparatus and the UE the at least one processor is further configured to cause the apparatus to:
determine, based on a radio frequency (RF) signal, a time of flight and an angle of arrival between the apparatus and the UE.

19. The apparatus of claim 18, wherein the RF signal includes at least one of an ultra-wideband (UWB) signal, a 5G mmW signal, and a PC5 signal.

20. The apparatus of claim 14, wherein the apparatus corresponds to a pedestrian UE and the UE corresponds to a vehicle UE.

21. The apparatus of claim 14, wherein the at least one processor is further configured to cause the at least one processor to:
determine a second location estimate of the apparatus based on one or more sensor measurements performed by the apparatus; and
send the second location estimate of the apparatus to the UE.

22. The apparatus of claim 21, wherein the at least one processor is further configured to cause the at least one processor to:
determine a first accuracy estimate associated with the first location estimate and a second accuracy estimate associated with the second location estimate.

23. The apparatus of claim 22, wherein the at least one processor is further configured to cause the at least one processor to:
select at least one of the first location estimate and the second location estimate based on a comparison of the first accuracy estimate and the second accuracy estimate.

24. The apparatus of claim 22, wherein the at least one processor is further configured to cause the at least one processor to:
determine a third location estimate of the apparatus based on a weighted combination of the first location estimate and the second location estimate, wherein the weighted combination is based on the first accuracy estimate and the second accuracy estimate.

25. The apparatus of claim 14, wherein the at least one processor is further configured to cause the at least one processor to:
obtain real-time kinematic (RTK) data associated with the positioning data corresponding to the UE; and
send the RTK data to the UE.

26. The apparatus of claim 14, wherein the UE corresponds to a public transportation vehicle.

27. A computer-readable medium comprising at least one instruction for causing a computer or processor to:
receive, by a first user equipment (UE), positioning data corresponding to a second UE;
determine a relative position between the first UE and the second UE; and
determine a first location estimate of the first UE based on the positioning data corresponding to the second UE and the relative position between the first UE and the second UE.

28. The computer-readable medium of claim 27, further comprising at least one instruction for causing the computer or processor to:
determine, based on a radio frequency (RF) signal, a time of flight and an angle of arrival between the first UE and the second UE, wherein the RF signal includes at least one of an ultra-wideband (UWB) signal, a 5G mmW signal, and a PC5 signal.

29. The computer-readable medium of claim 27, further comprising at least one instruction for causing the computer or processor to:
determine a second location estimate of the first UE based on one or more sensor measurements performed by the first UE; and
send the second location estimate of the first UE to the second UE.

30. An apparatus for wireless communications, comprising:
means for receiving, by a first user equipment (UE), positioning data corresponding to a second UE;
means for determining a relative position between the first UE and the second UE; and
means for determining a first location estimate of the first UE based on the positioning data corresponding to the second UE and the relative position between the first UE and the second UE.
